(19) United States
(12) Patent Application Publication
(10) Pub. No.: US 2011/0238494 A1
(43) Pub. Date: Sep. 29, 2011

(54) AUCTION SYSTEM FOR MAXIMIZING ADVERTISING EFFICIENCY BY EXPOSING ADVERTISEMENTS THROUGH INTERNET MEDIA AND METHOD OF OPERATING THE SAME

(76) Inventor: Yon Ho Park, Seoul (KR)

(21) Appl. No.: 13/132,472

(22) PCT Filed: Jun. 26, 2009
(86) PCT No.: PCT/KR2009/003463

§ 371 Date: Jun. 2, 2011

(30) Foreign Application Priority Data
Dec. 5, 2008 (KR) 10-2008-0123272

(51) Int. Cl. G06Q 30/00

(52) U.S. Cl. 705/14.46; 705/14.71

(57) ABSTRACT

An auction system for maximizing advertising efficiency by exposing an advertisement through Internet media, and a method of operating the auction system are provided. The auction system includes Internet media for providing information to an unspecified number of Internet users over the Internet, and having advertising areas. An auction server provides information about Internet media groups, in which some or all of the Internet media are grouped, to subscribing members, and selects one or more members from among members participating in an auction to post advertisements on any one of the Internet media groups. At least one advertiser client accesses the auction server, subscribes to the auction server as a member, inquires about the provided Internet media groups information, selects any one from among the Internet media groups, and enters a bidding price for the selected Internet media group.

### TECHNICAL FIELD

The present invention relates, in general, to an auction system for maximizing advertising efficiency by exposing an advertisement through Internet media and a method of operating the auction system, and, more particularly, an auction system for maximizing advertising efficiency a method of operating the auction system, in which an auction server provides information about a plurality of Internet media groups, in which some or all of the Internet media are grouped based on predetermined conditions such as information characteristics or types, and allows each advertiser client to occupy the advertising areas of one Internet media group among the plurality of Internet media groups through competition between advertiser clients using various auction methods, thereby allowing the operator of advertising areas on the Internet to maximize advertising revenue and allowing the advertiser clients to occupy advertising areas of Internet media belonging to the Internet media group and thus to acquire expected advertising effects.

### BACKGROUND ART

In conventional technology, in order to simultaneously post an advertisement on specific Internet media, advertising is contracted in such a way that an advertiser client pays for preset advertising costs through the Internet advertising system of an Internet media operator, or the Internet advertising system of an advertising agency which acts for the operator of Internet media. However, in this method, the operator of Internet media cannot maximize the amount of advertisement orders received, and an advertiser client cannot acquire as high an advertising effect as he or she expects because the advertisement thereof is not posted on Internet media at the desired frequency.

As another conventional technology, there is a method of conducting an auction for Internet media in the Internet advertising system of an Internet media operator or the Internet advertising system of an advertising agency which acts for the operator of Internet media, and selecting an advertiser client who will post an advertisement on the Internet media. However, in this method, in order to bid in an auction for specific Internet media, a plurality of advertiser clients must participate in an auction using the same payment method. Even if an advertiser client is selected to post an advertisement on the Internet media, the exposure rate of the advertisement to the Internet media and the advertising cost consumption rate corresponding to the exposure rate cannot be adjusted.

Therefore, what is urgently required is a more realistic and higher-utility solution capable of allowing the operator of specific Internet media to maximize advertising revenue using advertising areas of the Internet media thereof, and allowing an advertiser client to strategically conduct advertising by participating in an auction for Internet media using a desired payment method and thus being capable of adjusting the exposure rate of an advertisement to advertising areas present in the Internet media and the advertising cost consumption rate corresponding to the exposure rate.

### DISCLOSURE OF INVENTION

### Technical Problem

Accordingly, the present invention has been made keeping in mind the above problems occurring in the prior art, and an object of the present invention is to provide an auction system and a method of operating the auction system, in which an auction is conducted among advertiser clients for an Internet media group selected from among a plurality of Internet media groups, in which some or all of the Internet media are grouped, to occupy advertising areas present in Internet media without any limitations of a payment method, and in which the advertising areas of the Internet media group are provided to a plurality of advertiser clients selected depending on the maximum profit rates, so that the respective operators of the Internet media belonging to the Internet media group can maximize their advertising revenues using the advertising areas on their Internet media, and each advertiser client can strategically conduct advertising by participating in an auction for the Internet media group composed of Internet media using a desired payment method and thus being capable of adjusting the exposure rate of an advertisement to the advertising areas present in Internet media belonging to the Internet media group and the advertising cost consumption rate corresponding to the exposure rate.

### Technical Solution

In accordance with an embodiment of the present invention to accomplish the above object, there is provided an auction system for maximizing advertising efficiency by exposing an advertisement through Internet media, comprising Internet media for providing information to an unspecified number of Internet users over the Internet, and having advertising areas in which advertisements can be posted; an auction server for providing information about a plurality of Internet media groups, in which some or all of the Internet media are grouped, to subscribing members, and selecting one or more members who will post advertisements from among members participating in an auction to post advertisements on any one of the plurality of Internet media groups; and at least one advertiser client for accessing the auction server, subscribing to the auction server as a member who will post an advertisement, inquiring about the provided information about the plurality of Internet media groups, selecting any one from among the plurality of Internet media groups, and entering a bidding price for the selected Internet media group.

In accordance with another embodiment of the present invention to accomplish the above object, there is provided a method of operating an auction system for maximizing advertising efficiency by exposing an advertisement through Internet media, comprising a first step of a bid interface unit of an auction server providing information about a plurality of Internet media groups in which some or all of the Internet media are grouped to a relevant advertiser client, and then providing bidding details of other advertiser clients participating in an auction for an Internet media group selected by the advertiser client; a second step of the relevant advertiser client selecting any one from among the plurality of Internet media groups provided by the bid interface unit of the auction server, and the bid interface unit of the auction server receiving bidding details, including a bidding price and a payment method entered by the relevant advertiser client for the selected Internet media group; a third step of a database unit of the auction server storing the bidding details received through the bid interface unit; a fourth step of a bid processing unit of the auction server determining whether an auction period has arrived, and selecting one advertiser client or two or more advertiser clients who will post advertisements on the selected Internet media group depending on ranks determined by any one of maximum profit rates calculated using bidding prices, which are presented for the Internet media group selected by the advertiser clients and are stored in the database unit, maximum profit rates calculated using both the bidding prices presented by the advertiser clients for the Internet media group selected by the advertiser clients and users' click rates on advertisements of the advertiser clients, and maximum profit rates calculated using both the bidding prices presented by the advertiser clients and numbers of user actions occurring on the advertisements of the advertiser clients; and a fifth step of an advertisement transmission unit of the auction server transmitting advertisements of advertiser clients selected by the bid processing unit to the selected Internet media group.

In accordance with a further embodiment of the present invention to accomplish the above object, there is provided a method of operating an auction system for maximizing advertising efficiency by exposing an advertisement through Internet media, comprising the steps of an auction server providing a plurality of Internet media groups, in which some or all of the Internet media which provide information to Internet users over the Internet and have advertising areas enabling advertisements to be posted are grouped, to advertiser clients; the auction server selecting one or more advertiser clients, who will post advertisements on any one of the provided Internet media groups, through an auction; and the auction server transmitting advertisements of one or more advertiser clients selected for a specific Internet media group to the specific Internet media group by applying advertisement exposure rates differently depending on ranks of advertising revenues.

### Advantageous Effects

Accordingly, the present invention is advantageous in that an auction is conducted among advertiser clients for any one Internet media group selected from among a plurality of Internet media groups, in which some or all of the Internet media are grouped based on predetermined conditions such as information characteristics or types, without any limitations of a payment method, and the advertising areas of the Internet media group for which the auction was conducted are provided to a plurality of advertiser clients selected depending on the maximum profit rates. Accordingly, the operator of the Internet media group can maximize advertising revenue using advertising areas on its Internet media group. Further, each advertiser client can adjust the exposure rate of an advertisement to the advertising areas present in the Internet media group and the advertising cost consumption rate corresponding to the exposure rate by participating in an auction for the Internet media group using a desired payment method, thus strategically conducting advertising.

### BRIEF DESCRIPTION OF DRAWINGS

FIG. 1 is a diagram showing the construction of an auction system for maximizing advertising efficiency by exposing an advertisement through Internet media according to an embodiment of the present invention;

FIG. 2 is a diagram showing an example in which a list of Internet media groups is displayed in the bidding procedure of the auction system of FIG. 1;

FIG. 3 is a diagram showing an example in which bidding details of an Internet media group selected in the bidding procedure of the auction system of FIG. 1 are displayed; and

FIG. 4 is a flowchart showing a method of operating an auction system for maximizing advertising efficiency by exposing an advertisement through Internet media according to another embodiment of the present invention.

### MODE FOR THE INVENTION

Hereinafter, embodiments of the present invention will be described in detail with reference to the attached drawings.

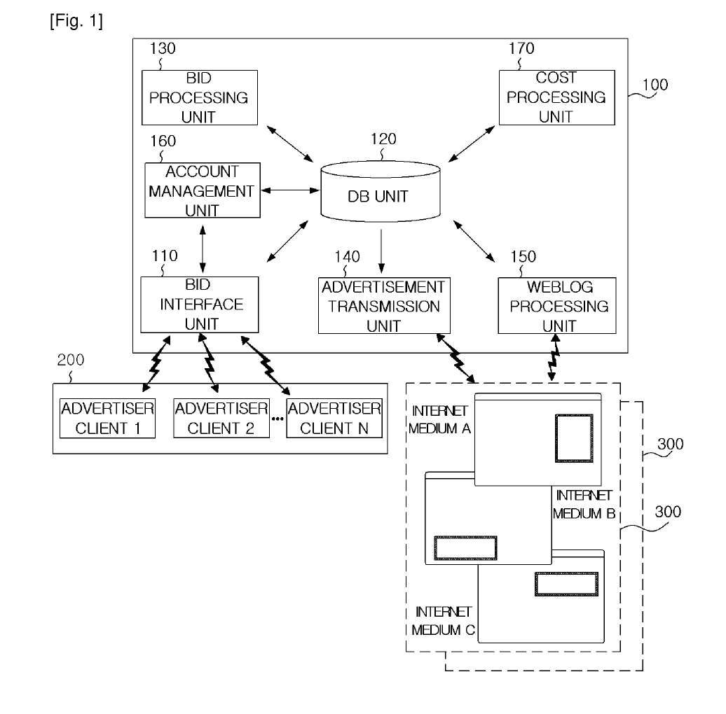

FIG. 1 is a diagram showing the construction of an auction system for maximizing advertising efficiency by exposing an advertisement through Internet media according to an embodiment of the present invention.

The auction system for maximizing advertising efficiency by exposing an advertisement through Internet media according to an embodiment of the present invention includes Internet media, an auction server 100, and advertiser clients 200. Each medium of the Internet media provides information to an unspecified number of Internet users over the Internet and has an advertising area in which an advertisement can be posted. The auction server 100 provides a plurality of Internet media groups 300, in which some or all of the Internet media are grouped, to subscribing members, and selects through an auction one or more members who will post advertisements from among members who participate in the auction to post advertisements on any one of the plurality of Internet media groups 300. Each of the advertiser clients 200 accesses the auction server 100, subscribes thereto as a member who will post an advertisement, inquires about the provided Internet media groups 300, selects any one from among the Internet media groups 300, and enters a bidding price for the selected Internet media group 300.

In detail, the auction server 100 includes a bid interface unit 110, a Database (DB) unit 120, a bid processing unit 130, and an advertisement transmission unit 140. The auction server 100 further includes a weblog processing unit 150, an account management unit 160, and a cost processing unit 170.

The bid interface unit 110 provides information about the plurality of Internet media groups 300 to the advertiser clients 200 so as to allow each of the advertiser clients 200 to select any one from among the Internet media groups 300, and receives a bidding price entered by an advertiser client 200 for the Internet media group 300 selected by the advertiser client 200.

That is, the bid interface unit 110 provides information about the Internet media groups 300, provides bidding details of other advertiser clients participating in an auction for the Internet media group 300 selected by the relevant advertiser client 200, and receives bidding details including both the bidding price for the Internet media group 300 selected by the relevant advertiser client 200 and the location information of the advertising areas of the selected Internet media group 300.

The information about the plurality of Internet media groups 300 includes location information of the advertising areas of Internet media belonging to each of the Internet media groups 300 and/or advertisement exposure rates of respective advertiser clients 200 corresponding to the ranks of maximum profit rates arbitrarily preset by the auction system for the plurality of Internet media groups 300.

The bidding details of each of the other advertiser clients 200 include at least one of the maximum profit rates calculated using bidding prices presented for the selected Internet media group 300, the maximum profit rates calculated using both the bidding prices and click rates obtained during a predetermined period in which advertisements were posted on the selected Internet media group 300, and the maximum profit rates calculated using both the bidding prices and the numbers of user actions occurring on the advertisements of the advertiser clients 200 posted on the selected Internet media group 300.

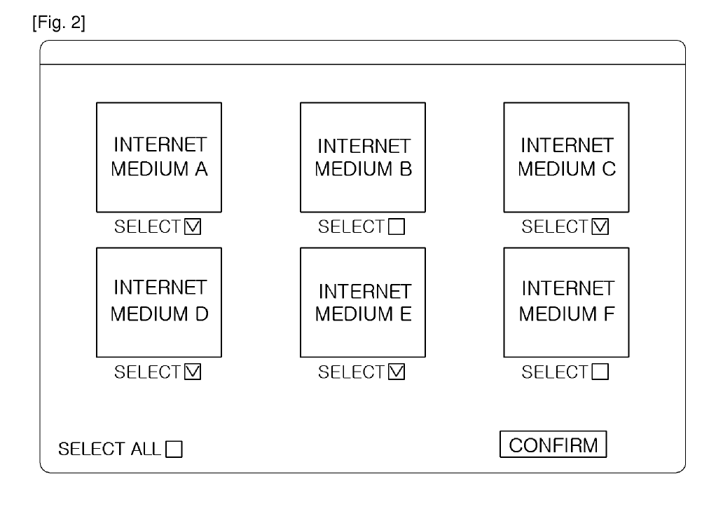

FIG. 2 is a diagram showing an example in which a list of Internet media groups is displayed in the bidding procedure of the auction system of FIG. 1.

As shown in FIG. 2, the bid interface unit 110 further provides a list of the plurality of Internet media groups 300 to each advertiser client 200. The advertiser client 200 may select one or more Internet media groups 300 from the list of Internet media groups 300. Further, the advertiser client 200 may select some or all of the Internet media belonging to one Internet media group 300.

The bid interface unit 110 further provides detailed information such as the number of exposures, the number of clicks, the minimum bidding price, the maximum bidding price, and the average click rate, corresponding to each Internet media group 300, for each unit period. Therefore, the respective Internet advertiser clients 200 determine whether to bid on an auction on the basis of the detailed information.

The term ‘number of exposures’ means the number of times that an advertisement is exposed to Internet users through the Internet media group 300 for each unit period.

The term ‘minimum bidding price’ means the minimum auction bidding price presented by the advertiser clients 200 who posted advertisements on the Internet media group 300 during a previous auction period.

The term ‘maximum bidding price’ means the maximum auction bidding price presented by the advertiser clients 200 who posted advertisements on the Internet media group 300 during a previous auction period.

The term ‘average click rate’ means a value calculated as the ratio of the number of exposures, which is the number of times that an advertisement is exposed to the Internet users for each unit period through the Internet media group 300, to the number of clicks, which is the number of times that the Internet users select the exposed advertisement.

When each advertiser client 200 selects a specific Internet media group 300 and determines whether to bid on an auction, the bid interface unit 110 may allow the advertiser client 200 to enter a bidding price for the selected Internet media group 300.

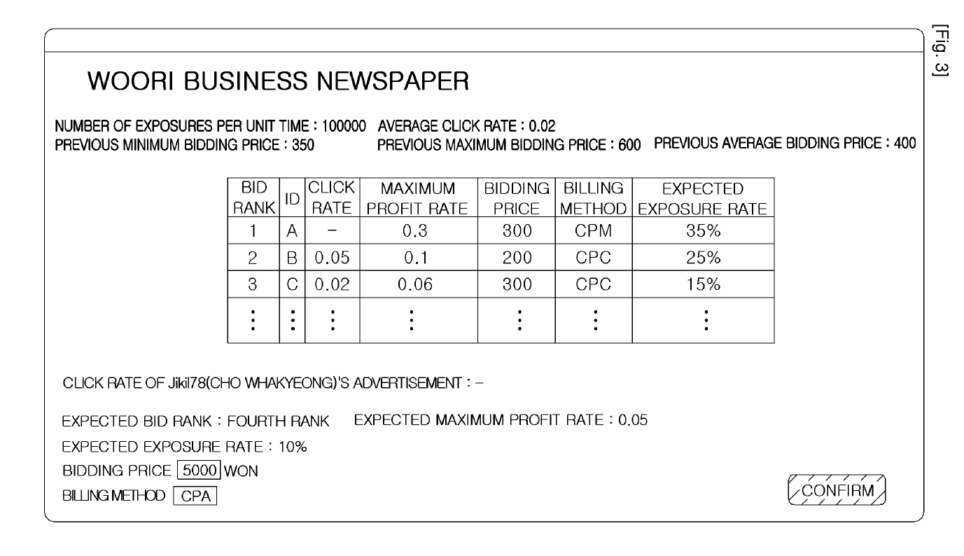

FIG. 3 is a diagram showing an example in which bidding details of an Internet media group selected in the bidding procedure of the auction system according to the present invention are displayed.

As shown in FIG. 3, the bid interface unit 110 further provides bidding details, including the bidding prices, the maximum profit rates and the click rates of other advertiser clients 200 participating in an auction for a selected Internet media group 300, to a relevant advertiser client 200.

Furthermore, the bid interface unit 110 receives advertisements to be posted on the Internet media group 300 when advertiser clients 200 make a successful bid in the auction.

Any one of banner advertisements, keyword advertisements, text advertisements and video advertisements may be selectively input as the advertisements to be posted on the Internet media group 300.

The DB unit 120 stores the bidding details which are received from the bid interface unit 110 and include bidding prices, click rates, the maximum profit rates, and payment methods, and further stores detailed information about the Internet media belonging to the selected Internet media group 300.

Further, the DB unit 120 stores the information collected by the weblog processing unit 150, that is, exposure information and click information on advertisements posted on Internet media belonging to each of the Internet media groups 300, and the number of user actions occurring on the posted advertisements. The exposure information includes the number of exposures of the advertisements, and the click information includes the number of clicks on the advertisements. The exposure information and the click information are provided to the advertiser clients 200 through the bid interface unit 110. The user actions refer to actions of Internet users expected by the advertiser clients 200 to be realized through advertisements, such as member subscription and product purchase.

Furthermore, the DB unit 120 stores advertisements to be posted on the Internet media group 300.

The bid processing unit 130 selects one or more advertiser clients 200 who will post advertisements on the Internet media group 300, on the basis of the bidding details stored in the DB unit 120.

The bid processing unit 130 selects one or more advertiser clients 200 who will post advertisements on the Internet media group 300, depending on ranks determined by any one of the maximum profit rates calculated using bidding prices, the maximum profit rates calculated using both the bidding prices and click rates of users on the advertisements, and the maximum profit rates calculated using both the bidding prices and the numbers of user actions occurring on the advertisements.

When a relevant advertiser client 200 is selected according to the ranks determined by the maximum profit rates, the maximum profit rates are calculated using click rates, bidding prices, the numbers of user actions, and the number of exposures of advertisements, which are obtained during a predetermined period in which the advertiser clients 200 previously posted advertisements (in this case, each click rate is calculated as the ratio of the number of exposures of an advertisement to the number of clicks on the advertisement).

When an advertiser client 200 has a history of previously posting the same advertisement on the selected Internet media group 300, a click rate obtained during a period in which the advertisement was previously posted is used. Further, when the advertiser client 200 does not have a history of previously posting the same advertisement on the selected Internet media group 300, the average click rate of the selected Internet media group 300 is used, or, alternatively, an arbitrary value preset by the auction server 100 is used instead of a click rate, thus the maximum profit rate may be calculated. When the maximum profit rate is calculated using the average click rate of the Internet media group 300, fair opportunities are assigned to some degree to new advertiser clients 200 who participate first in an auction in comparison with existing advertiser clients 200. An advertiser client 200 who will post an advertisement can be freely selected using the maximum profit rate without differentiating between respective payment methods entered by respective advertiser clients 200, that is, without any limitations of a payment method.

The maximum profit rate is calculated for respective payment methods as follows:
Cost Per Click (CPC) payment method: bidding price×click rate
Cost Per Mile (CPM) payment method: bidding price×1/1000
Cost Per Action (CPA) payment method: bidding price×number of user actions/number of exposures

Furthermore, an advertiser client 200 may be selected depending on the ranks of bidding prices.

The bid processing unit 130 selects one advertiser client, or two or more advertiser clients, on the basis of the bidding details.

The bid processing unit 130 periodically re-selects one or more advertiser clients 200, who will post advertisements on the Internet media group 300, at regular periods set in the auction server 100.

The advertisement transmission unit 140 transmits the advertisements of the advertiser clients 200 selected by the bid processing unit 130 to the Internet media group 300. The advertisement transmission unit 140 simultaneously transmits advertisements stored in the DB unit 120 to the Internet media group selected by the advertiser clients 200. When two or more advertiser clients 200 are selected for the Internet media group 300, advertisements are transmitted to the Internet media group 300 by applying the exposure rates of advertisements differently depending on the ranks of bidding prices or the maximum profit rates.

The weblog processing unit 150 collects the number of exposures and the number of clicks on the advertisements transmitted by the advertisement transmission unit 140, and the number of user actions occurring on the transmitted advertisements, and stores the collected information in the DB unit 120.

The account management unit 160 checks the balances of the bank accounts of the advertiser clients 200, and requests the advertiser clients 200 to deposit an amount of money corresponding to advertising costs when the balance of each bank account is less than the minimum balance preset in the auction server 100.

The cost processing unit 170 charges the advertiser clients 200 advertising costs on the basis of the information collected by the weblog processing unit 150, that is, the number of exposures and the number of clicks on the advertisements and the number of user actions occurring on the advertisements, with respect to Internet media belonging to the Internet media group 300.

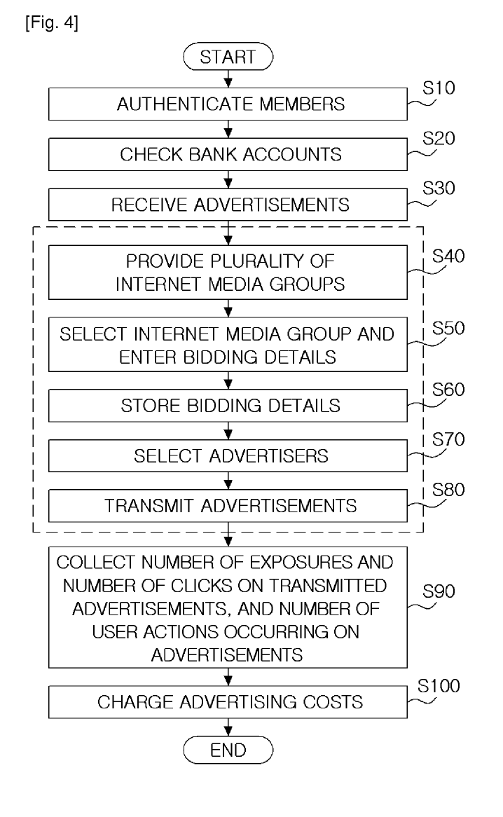

FIG. 4 is a flowchart showing a method of operating an auction system for maximizing advertising efficiency by exposing an advertisement through Internet media according to another embodiment of the present invention. The method of operating the auction system, which includes an auction server for providing advertising areas of Internet media to advertiser clients over the Internet and which maximizes advertising efficiency by exposing an advertisement through the Internet media, will be described below.

As shown in FIG. 4, the method of operating the auction system for maximizing advertising efficiency by exposing an advertisement through Internet media according to the embodiment of the present invention includes the step S40 of the auction server providing to advertiser clients a plurality of Internet media groups, in which some or all of Internet media that provide information to Internet users over the Internet and have advertising areas enabling advertisements to be posted therein are grouped; the steps S50, S60 and S70 of the auction server selecting one or more advertiser clients, who will post advertisements on any one of the plurality of Internet media groups, through an auction; and the step S80 of the auction server transmitting the advertisements of the one or more advertiser clients, selected for a specific Internet media group, to the specific Internet media group by applying the exposure rates of the advertisements differently depending on the ranks of advertising revenues.

In detail, the method of operating the auction system for maximizing advertising efficiency by exposing an advertisement through Internet media according to the embodiment of the present invention includes the first step S40, the second step S50, the third step S60, the fourth step S70 and the fifth step S80. At the first step S40, the bid interface unit 110 of the auction server 100 provides to a relevant advertiser client 200 a plurality of Internet media groups 300 in which some or all of the Internet media are grouped, detailed information such as the number of exposures, the number of clicks, the minimum bidding prices, the maximum bidding prices, and average click rates (in this case, each average click rate is calculated as the ratio of the number of exposures to the number of clicks which is the number of times that Internet users select an advertisement exposed through the Internet media group) which are obtained for each previous unit period with respect to the plurality of Internet media groups 300, and bidding details including the bidding prices and payment methods of other advertiser clients 200 participating in an auction for an Internet media group 300 selected by the advertiser clients 200 and click rates obtained during a predetermined period in which the advertisements of other advertiser clients were previously posted. At the second step S50, one of the plurality of Internet media groups 300 provided by the bid interface unit 110 of the auction server 100 is selected by the relevant advertiser client 200, and the bid interface unit 110 of the auction server 100 receives bidding details including a bidding price and a payment method entered by the relevant advertiser client 200 for the selected Internet media group 300. At the third step S60, the DB unit 120 of the auction server 100 stores the bidding details entered through the bid interface unit 110. At the fourth step S70, the bid processing unit 130 of the auction server 100 determines whether an auction period has arrived, and thus selects one advertiser client 200 or two or more advertiser clients 200 who will post advertisements on the selected Internet media group 300 depending on ranks determined by any one of the maximum profit rates calculated using bidding prices presented by the advertiser clients 200 for the selected Internet media group 300, the maximum profit rates calculated using both the bidding prices presented by the advertiser clients 200 for the selected Internet media group 300 and click rates obtained during a predetermined period in which the advertisements of the advertiser clients 200 were posted (when the advertiser clients have no history of previously posting advertisements, the average click rate of the selected Internet media 300 is used, or, alternatively, an arbitrary value preset by the auction server 100 is used instead of the click rate), and the maximum profit rates calculated using both the bidding prices presented by the advertiser clients 200 for the selected Internet media group 300 and the number of user actions occurring on the advertisements of the advertiser clients 200. At the fifth step S80, the advertisement transmission unit 140 of the auction server 10 transmits the advertisements of the advertiser clients 200 selected by the bid processing unit 130 to the selected Internet media group 300.

The operation method further includes, before the first step, the step S10 of the bid interface unit 110 of the auction server 100 allowing respective advertiser clients who access the auction server 100 to subscribe thereto as members, the step S20 of the account management unit 160 of the auction server 100 checking the balances of the bank accounts of the advertiser clients 200, and the step S30 of the bid interface unit 110 of the auction server 100 receiving advertisements from the advertiser clients 200. The operation method further includes, after the fifth step, the step S90 of the weblog processing unit 150 of the auction server 100 collecting the number of exposures and the number of clicks on the advertisements transmitted to the Internet media belonging to the Internet media group 300 and the number of user actions occurring on the transmitted advertisements, and the step S100 of the cost processing unit 170 of the auction server 100 charging the advertiser clients 200 advertising costs for the Internet media belonging to the Internet media group 300 on the basis of the information collected by the weblog processing unit 150, that is, the number of exposures and the number of clicks on the advertisements and the number of user actions occurring on the advertisements.

Hereinafter, the method of operating the auction system for maximizing advertising efficiency by exposing an advertisement through Internet media according to the embodiment of the present invention will be described in detail.

First, each advertiser client 200 accesses the auction server 100 and subscribes thereto as a member through the bid interface unit 110 to participate in an auction for the Internet media group 300 at step S10. In the case of an advertiser client 200 who has already subscribed as a member, the account management unit 160 of the auction server 100 checks the balance of the bank account of the advertiser client 200, and in the case of an advertiser client 200 who has not subscribed as a member, after the advertiser client 200 subscribes to the auction server as a member, the account management unit 160 of the auction server 100 checks the balance of the bank account of the advertiser client 200 at step S20.

When the balance of the bank account is checked, the account management unit 160 of the auction server 100 determines whether an amount of money above the minimum balance required to post an advertisement is deposited in the bank account of the advertiser client 200. If it is determined that an amount of money above the minimum balance preset by the auction server 100 is not deposited in the bank account, the account management unit 160 requests the advertiser client 200 to deposit an amount of money corresponding to advertising costs above at least the minimum balance.

At step S30, the bid interface unit 110 of the auction server 100 receives advertisements to be posted on the Internet media group 300 when one or more advertiser clients 200 who will post advertisements are selected at step S70 which will be described later. Preferably, the received advertisements may be any one of banner advertisements, keyword advertisements, text advertisements and video advertisements.

Next, the first step S40 will be described in detail. The bid interface unit 110 of the auction server 100 provides a list of Internet media belonging to the selected Internet media group 300 to a relevant advertiser client 200. The bid interface unit 110 further provides detailed information such as the number of exposures, the number of clicks, the minimum bidding prices, the maximum bidding prices, and the average click rates on advertisements posted on the Internet media group 300 for each previous unit time, and respective advertiser clients 200 determine whether to bid on the basis of the detailed information.

Further, at the first step S40, the bid interface unit 110 of the auction server 100 provides the bidding details of other advertiser clients 200 participating in the auction for the Internet media group 300 selected by the relevant advertiser client 200, for example, the bidding prices, payment methods and maximum profit rates of other advertiser clients 200.

At the second step S50, the relevant advertiser client 200 selects an Internet media group on which an advertisement is desired to be posted, from among the plurality of Internet media groups 300, with reference to the detailed information of the Internet media groups 300 provided by the bid interface unit 110. When a specific Internet media group 300 is selected, the relevant advertiser client 200 enters a bidding price and a payment method for the selected Internet media group 300 with reference to the bidding details of other advertiser clients 200 provided by the bid interface unit 110, for example, bidding prices, maximum profit rates, etc.

At the third step S60, the DB unit 120 of the auction server 100 stores the bidding details such as the bidding price and the payment method, entered by the relevant advertiser client 200 through the bid interface unit 110.

At the fourth step S70, the bid processing unit 130 selects one or more advertiser clients 200 depending on the ranks determined by any one of the maximum profit rates calculated using bidding prices at an auction, the maximum profit rates calculated using both the bidding prices at the auction and users' click rates on advertisements, and the maximum profit rates calculated using both the bidding prices at the auction and the numbers of user actions occurring on the advertisements.

The fourth step S70 includes the step S71 of the bid processing unit 130 of the auction server 100 determining whether an auction period has arrived, the step S72 of the bid processing unit 130 of the auction server 100 selecting one or more advertiser clients 200 depending on the ranks of the maximum profit rates, and the step S73 of the bid processing unit 130 of the auction server 100 selecting one or more advertiser clients 200 depending on the ranks of bidding prices.

That is, the bid processing unit 130 of the auction server 100 determines whether an auction period has arrived at step S71. If it is determined that the auction period has not arrived, the bid processing unit 130 returns to the initial step and enters a bidding standby state. If it is determined that the auction period has arrived, the bid processing unit 130 selects one or more advertiser clients 200 who will post advertisements on the Internet media group 300.

Thereafter, the bid processing unit 130 of the auction server 100 selects advertiser clients depending on the ranks of the maximum profit rates at step S72. The bid processing unit 130 of the auction server 100 selects one or more advertiser clients 200 who will post advertisements on the Internet media group 300 depending on the ranks of the maximum profit rates. The maximum profit rates are calculated using the click rates, the bidding prices, the number of user actions, and the number of exposures which are obtained during a predetermined period in which the advertiser clients 200 previously posted the advertisements, and are calculated using different methods for respective payment methods, as described above.

When a relevant advertiser client 200 has a history of previously posting the same advertisement on the selected Internet media group 300, a click rate obtained during the period in which the advertisement was previously posted is used. When a relevant advertiser client 200 does not have a history of previously posting the same advertisement on the selected Internet media group 300, the average click rate of the selected Internet media group 300 is used, or an arbitrary value preset by the auction server 100 is used instead of a click rate, and thus the maximum profit rate may be used. Advertiser clients 200 participating for the first time in an auction are allowed to use the average click rate of the Internet media group 300, and thus fair opportunities may be assigned to some degree between existing advertiser clients and new advertiser clients.

As described above, through the use of the maximum profit rates, since advertising revenues to be created by advertising clients 200 bidding on the auction by selecting payment methods may be expected, ranks based on the maximum profit rates are determined, and thus one or more advertiser clients 200 who will post advertisements can be selected.

From among a plurality of advertiser clients participating in an auction, one advertiser client 20 or two or more advertiser clients 200 may be selected to post advertisements on the Internet media group 300 on the basis of the bidding details.

The process for selecting advertiser clients 200 when the bid processing unit 130 of the auction server 100 selects advertiser clients 200 depending on the ranks of the maximum profit rates at step S72 will next be described in detail.

It is assumed that six advertiser clients A, B, C, D, E, and F desire to occupy a specific Internet media group 300 over the Internet and post advertisements on the Internet media group 300. Currently, the auction system of the present invention is intended to select advertiser clients who will post advertisements on the Internet media group 300. Among the six advertiser clients, A, B, D and F are currently posting advertisements on the Internet media group 300, and C and E desire to post advertisements on the Internet media group 300 for the first time. The average click rate of the Internet media group 300 is 0.02. It is assumed that, for the advertiser client D, the number of exposures of an advertisement was 100,000 last month, and one user action occurred. Currently, an auction is being conducted to select advertiser clients for the next period, and bidding details of respective advertiser clients are given by the following Table 1.

TABLE 1

| | Advertiser Client | | | | | |
|---|---|---|---|---|---|---|
| | A | B | C | D | E | F |
| Payment | CPM | CPC | CPC | CPA | CPC | CPM |
| method | | | | | | |
| Bidding | 300 | 200 | 300 | 5000 | 150 | 20 |
| price | | | | | | |
| Click rate | — | 0.05 | 0.02 | — | 0.02 | — |
| Maximum | 0.3 | 0.1 | 0.06 | 0.05 | 0.03 | 0.02 |
| profit | | | | | | |
| Exposure | 35 | 25 | 15 | 10 | 8 | 7 |
| rate (%) | | | | | | |

As the click rates of advertiser clients C and E who are bidding on an auction for the first time, the average click rate 0.02 of the Internet media group 300 is assigned, and thus the maximum profit rates thereof are calculated.

The maximum profit rates for respective payment methods are calculated as follows:
Cost Per Click (CPC) payment method: bidding price×click rate
Cost Per Mile (CPM) payment method: bidding price×1/1000
Cost Per Action (CPA) payment method: bidding price×number of user actions/number of exposures

Therefore, when the maximum profit rates are calculated using the above methods, the advertiser clients 200 who will post advertisements on the Internet media group 300 are selected in order of the A, B, C, D, E and F ranks.

When the bid processing unit 130 of the auction server 100 selects two or more advertiser clients 200 who will post advertisements on the Internet media group 300, it may transmit the advertisements to the Internet media group 300 by applying exposure rates differently depending on the ranks of the maximum profit rates thereof.

When the bid processing unit 130 of the auction server 100 selects advertiser clients 200 depending on the ranks of bidding prices at step S73, one advertiser client 200, or two or more advertiser clients 200, are selected to post advertisements on the Internet media group 300, depending on the ranks of the bidding prices, from among the plurality of advertiser clients 200 participating in the auction.

The process for selecting advertiser clients at step S73 will be described in detail with reference to Table 1. That is, when the bid processing unit 130 of the auction server 100 selects advertiser clients 200 depending on the ranks of bidding prices, the advertiser clients 200 are selected using only the ranks of bidding prices, and thus the advertiser clients 200 are selected in the order of D, A, C, B, E, and F depending on the ranks of bidding prices.

At the fifth step S80, the advertisement transmission unit 140 transmits the advertisements of the advertiser clients 200, selected by the bid processing unit 130 of the auction server 100 at the fourth step, to the Internet media group 300. The advertisement transmission unit 140 transmits advertisements stored in the DB unit 120 to the Internet media group 300. When two or more advertiser clients 200 are selected to post advertisements on the Internet media group 300, the advertisement transmission unit 140 may transmit the stored advertisements by applying respective advertisement exposure rates differently depending on the ranks of maximum profit rates or bidding prices.

At step S90, the weblog processing unit 150 of the auction server 100 collects the number of exposures and the number of clicks on respective advertisements, transmitted from the advertisement transmission unit 140 to the Internet media belonging to the Internet media group 300, and the number of user actions occurring on the advertisements, and stores the collected information in the DB unit 120.

At step S100, the cost processing unit 160 charges the advertiser clients 200 advertising costs for the Internet media belonging to the Internet media group 300 on the basis of the information collected by the weblog processing unit 150, that is, the number of exposures and the number of clicks on the advertisements and the number of user actions occurring on the advertisements.

For example, according to the payment methods entered by the advertiser clients 200 at the time of bidding on an auction, advertising costs are charged using any one of the payment methods selected by a corresponding advertiser client from among a Cost Per Click (CPC) payment method, a Cost Per Mile (CPM) payment method, and a Cost Per Action (CPA) payment method at step S100.

First, when a CPC payment method is used, advertising costs can be calculated using the number of clicks on and bidding price of each advertisement posted on the Internet media group 300 during a period in which the advertisement was posted. Further, when a CPM payment method is used, advertising costs can be calculated using the number of exposures and bidding price of each advertisement posted on the Internet media group 300 during a period in which the advertisement was posted. Further, when a CPA payment method is used, advertising costs can be calculated using the number of user actions, which each advertiser client 200 expects for the advertisement thereof, and the bidding price of the advertisement during a period in which the advertisement was posted.

Therefore, in the present invention, an auction is conducted among advertiser clients 200 to occupy advertising areas present in an Internet media group 300 composed of Internet media, without any limitations of a payment method, and the advertising areas of the Internet media group 300 are provided to a plurality of advertiser clients 200 selected based on the maximum profit rates. Accordingly, respective operators of the Internet media group 300 can maximize their advertising revenues using the advertising areas of the Internet media group 300. Further, advertiser clients 200 are capable of adjusting the exposure rates of advertisements to the Internet media group 300 and the advertising cost consumption rates corresponding to the exposure rates by participating in an auction using desired payment methods, thus strategically conducting advertising.

### INDUSTRIAL APPLICABILITY

Accordingly, the present invention is advantageous in that an auction is conducted among advertiser clients for any one Internet media group selected from among a plurality of Internet media groups, in which some or all of the Internet media are grouped based on predetermined conditions such as information characteristics or types, without any limitations of a payment method, and the advertising areas of the Internet media group for which the auction is conducted are provided to a plurality of advertiser clients selected depending on the maximum profit rates. Accordingly, the operator of the Internet media group can maximize advertising revenue using advertising areas on its Internet media group. Further, each advertiser client can adjust the exposure rate of an advertisement to the advertising areas present in the Internet media group and the advertising cost consumption rate corresponding to the exposure rate by participating in an auction for the Internet media group using a desired payment method, thus strategically conducting advertising.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An auction system for maximizing advertising efficiency by exposing an advertisement through Internet media, comprising:
Internet media for providing information to an unspecified number of Internet users over the Internet, and having advertising areas in which advertisements can be posted;
an auction server for providing information about a plurality of Internet media groups, in which some or all of the Internet media are grouped, to subscribing members, and selecting one or more members who will post advertisements from among members participating in an auction to post advertisements on any one of the plurality of Internet media groups; and
at least one advertiser client for accessing the auction server, subscribing to the auction server as a member who will post an advertisement, inquiring about the provided information about the plurality of Internet media groups, selecting any one from among the plurality of Internet media groups, and entering a bidding price for the selected Internet media group.

2. The auction system according to claim 1, wherein the auction server comprises:
a bid interface unit for providing the information about the Internet media groups to the advertiser client, providing bidding details of other advertiser clients participating in the auction for the Internet media group selected by the advertiser client, and receiving bidding details including a bidding price for the Internet media group selected by the advertiser client and location information of advertising areas of the selected Internet media group;
a database unit for storing the bidding details received through the bid interface unit;
a bid processing unit for selecting one advertiser client or two or more advertiser clients who will post advertisements on the selected Internet media group depending on ranks determined by any one of maximum profit rates calculated using bidding prices presented by the advertiser clients for the selected Internet media group, maximum profit rates calculated using both the bidding prices presented by the advertiser clients for the selected Internet media group and users' click rates on advertisements of the advertiser clients, and maximum profit rates calculated using both the bidding prices presented by the advertiser clients and number of user actions occurring on the advertisements of the advertiser clients; and
an advertisement transmission unit for transmitting advertisements of advertiser clients selected by the bid processing unit to the Internet media group selected by the advertiser clients.

3. The auction system according to claim 2, wherein the information about the plurality of Internet media groups includes location information of the advertising areas of Internet media belonging to each of the plurality of Internet media groups and/or advertisement exposure rates of respective advertiser clients corresponding to ranks of maximum profit rates arbitrarily designated by the auction system for the plurality of Internet media groups.

4. The auction system according to claim 2, wherein the bidding details of each of the other advertiser clients include at least one of maximum profit rates calculated using the bidding prices presented for the selected Internet media group, maximum profit rates calculated using both the bidding prices and click rates obtained during a predetermined period in which advertisements were posted on the selected Internet media group, and maximum profit rates calculated using both the bidding prices and number of user actions occurring on advertisements of advertiser clients posted on the selected Internet media group.

5. The auction system according to claim 2, wherein the bid interface unit further provides a list of Internet media belonging to each of the plurality of Internet media groups to the advertiser clients.

6. The auction system according to claim 2, wherein the bid interface unit further receives detailed information about advertisements to be posted on the selected Internet media group from the advertiser clients.

7. The auction system according to claim 2, wherein the bid processing unit periodically re-selects advertiser clients, who will post advertisements on the selected Internet media group, at regular periods set in the auction server, depending on ranks determined by the maximum profit rates.

8. The auction system according to claim 2, wherein the advertisement transmission unit transmits advertisements to the selected Internet media group by applying exposure rates differently depending on ranks of the maximum profit rates when the bid processing unit selects two or more advertiser clients who will post advertisements on the selected Internet media group.

9. (canceled)

10. The auction system according to claim 2, further comprising:
an account management unit for checking balances of bank accounts of the advertiser clients and then requesting the advertiser clients to deposit an amount of money corresponding to advertising costs;
a weblog processing unit for collecting number of exposures and number of clicks on advertisements of the selected advertiser clients, transmitted by the advertisement transmission unit, and number of user actions occurring on the transmitted advertisements with respect to Internet media belonging to the Internet media group selected by the selected advertiser clients, and storing collected information in the database unit; and
a cost processing unit for charging the advertiser clients advertising costs depending on information collected by the weblog processing unit, that is, the number of exposures and the number of clicks on the advertisements and the number of user actions occurring on the transmitted advertisements, with respect to the Internet media belonging to the selected Internet media group.

11. The auction system according to claim 10, wherein the cost processing unit charges advertising costs using one method selected by each advertiser client from among a Cost Per Click (CPC) payment method, a Cost Per Mile (CPM) payment method and a Cost Per Action (CPA) payment method.

12. A method of operating an auction system for maximizing advertising efficiency by exposing an advertisement through Internet media, comprising the step of:
a first step of a bid interface unit of an auction server providing information about a plurality of Internet media groups in which some or all of the Internet media are grouped to a relevant advertiser client, and then providing bidding details of other advertiser clients participating in an auction for an Internet media group selected by the advertiser client;
a second step of the relevant advertiser client selecting any one from among the plurality of Internet media groups provided by the bid interface unit of the auction server, and the bid interface unit of the auction server receiving bidding details, including a bidding price and a payment method entered by the relevant advertiser client for the selected Internet media group;
a third step of a database unit of the auction server storing the bidding details received through the bid interface unit;
a fourth step of a bid processing unit of the auction server determining whether an auction period has arrived, and selecting one advertiser client or two or more advertiser clients who will post advertisements on the selected Internet media group depending on ranks determined by any one of maximum profit rates calculated using bidding prices, which are presented for the Internet media group selected by the advertiser clients and are stored in the database unit, maximum profit rates calculated using both the bidding prices presented by the advertiser clients for the Internet media group selected by the advertiser clients and users' click rates on advertisements of the advertiser clients, and maximum profit rates calculated using both the bidding prices presented by the advertiser clients and number of user actions occurring on the advertisements of the advertiser clients; and
a fifth step of an advertisement transmission unit of the auction server transmitting advertisements of advertiser clients selected by the bid processing unit to the selected Internet media group.

13. The method according to claim 12, wherein the information about the plurality of Internet media groups includes location information of the advertising areas of Internet media belonging to the plurality of Internet media groups and/or advertisement exposure rates of respective advertiser clients corresponding to ranks of maximum profit rates arbitrarily designated by the auction system for the plurality of Internet media groups.

14. The method according to claim 12, wherein the bidding details of each of the other advertiser clients include at least one of maximum profit rates calculated using the bidding prices presented for the selected Internet media group, maximum profit rates calculated using both the bidding prices and click rates obtained during a predetermined period in which advertisements were posted on the selected Internet media group, and maximum profit rates calculated using both the bidding prices and number of user actions occurring on advertisements of advertiser clients posted on the selected Internet media group.

15. The method according to claim 12, wherein the first step comprises the bid interface unit of the auction server further providing a list of Internet media belonging to each of the plurality of Internet media groups to the advertiser clients.

16. The method according to claim 12, further comprising, after the fifth step, the step of periodically repeating the fourth step at regular periods preset in the auction server, thus re-selecting one or more advertiser clients who will post advertisements on the selected Internet media group.

17. The method according to claim 12, wherein the fifth step is performed to transmit advertisements to the selected Internet media group by applying exposure rates differently depending on ranks of the maximum profit rates when two or more advertiser clients who will post advertisements on the selected media group are selected by the bid processing unit of the auction server at the fourth step.

18. The method according to claim 12, further comprising,
before the first step, the steps of the bid interface unit of the auction server allowing advertiser clients who access the auction server to subscribe as members; an account management unit of the auction server checking balances of bank accounts of the advertiser clients; and the bid interface unit of the auction server receiving advertisements from the advertiser clients; and
after the fifth step, the steps of a weblog processing unit of the auction server collecting number of exposures and number of clicks on the transmitted advertisements and number of user actions occurring on the transmitted advertisements with respect to Internet media belonging to the selected Internet media group; and a cost processing unit of the auction server charging the advertiser clients advertising costs depending on information collected by the weblog processing unit, that is, the number of exposures and the number of clicks on the advertisements and the number of user actions occurring on the transmitted advertisements.

19. The method according to claim 18, wherein the step of the cost processing unit of the auction server charging the advertiser clients advertising costs depending on information collected by the weblog processing unit, that is, the number of exposures and the number of clicks on the advertisements and the number of user actions occurring on the transmitted advertisements is performed such that the cost processing unit of the auction server charges advertising costs using one method selected by each advertiser client from among a Cost Per Click (CPC) payment method, a Cost Per Mile (CPM) payment method, and a Cost Per Action (CPA) payment method.

20. A method of operating an auction system for maximizing advertising efficiency by exposing an advertisement through Internet media, comprising the steps of:
an auction server providing a plurality of Internet media groups, in which some or all of the Internet media which provide information to Internet users over the Internet and have advertising areas enabling advertisements to be posted are grouped, to advertiser clients;
the auction server selecting one or more advertiser clients, who will post advertisements on any one of the provided Internet media groups, through an auction; and
the auction server transmitting advertisements of one or more advertiser clients selected for a specific Internet media group to the specific Internet media group by applying advertisement exposure rates differently depending on ranks of advertising revenues.

21. The method according to claim 20, wherein the ranks of the advertising revenues are determined by any one of maximum profit rates calculated using bidding prices presented by the selected advertiser clients for the specific Internet media group, maximum profit rates calculated using both the bidding prices presented by the selected advertiser clients for the specific Internet media group and users' click rates on advertisements of the advertiser clients, and maximum profit rates calculated using both the bidding prices presented by the selected advertiser clients for the specific Internet media group and numbers of user actions occurring on the advertisements of the advertiser clients.
